(19) United States
(12) Patent Application Publication
(10) Pub. No.: US 2008/0285978 A1
(43) Pub. Date: Nov. 20, 2008

(54) OPTICAL HYBRID MODULE

(75) Inventors: Kwang Seong Choi, Seoul (KR); Yong Duck Chung, Daejeon (KR); Jae Sik Sim, Daejeon (KR); Jong Tae Moon, Daejeon (KR); Hyun Kyu Yu, Daejeon (KR); Je Ha Kim, Daejeon (KR)

Correspondence Address: RABIN & Berdo, PC, 1101 14TH STREET, NW, SUITE 500, WASHINGTON, DC, 20005, US

(73) Assignee: Electronics and Telecommunications Research Institute, Daejeon (KR)

(21) Appl. No.: 12/053,694

(22) Filed: Mar. 24, 2008

(30) Foreign Application Priority Data
May 14, 2007 (KR) 10-2007-0046710

(51) Int. Cl. H04B 10/00

(52) U.S. Cl. 398/139

(57) ABSTRACT

Provided is an optical hybrid module in which an optical device, a filter, an amplifier and an antenna are hybrid-integrated, which includes: a silicon optical bench disposed on a substrate and having an optical fiber and an optical device; an amplifier disposed on the substrate and connected to the optical device disposed on the silicon optical bench to amplify a signal transmitted from the optical device; and an antenna disposed on the substrate to be connected to the amplifier and transmitting a signal amplified by the amplifier. Thus, a foot-print module may be embodied by disposing an antenna and a filter on a single- or multi-layer substrate and providing a bias required for the optical device and the amplifier through a solder ball. Also, due to the antenna and filter disposed on the substrate, an expensive connector is not needed, and thus a production costs can be reduced.

### CROSS-REFERENCE TO RELATED APPLICATION

This application claims priority to and the benefit of Korean Patent Application No. 2007-46710, filed May 14, 2007, the disclosure of which is incorporated herein by reference in its entirety.

### BACKGROUND

1. Field of the Invention

The present invention relates to an optical hybrid module, and more particularly, to an optical hybrid module in which an optical device, a filter, an amplifier and an antenna are hybrid-integrated.

The present invention is derived from a project entitled “SoP (system on Package) for 60 GHz Pico cell Communication [2005-S-039-03]” conducted as an IT R&D program for the Ministry of Information and Communication (Republic of Korea).

2. Discussion of Related Art

A recent telecommunication environment has exhibited a trend in which wired and wireless communications are unified, and communication, broadcasting and internet are united to be developed to one broadband network. In order to provide a high-speed wireless multimedia service to a subscriber according to the trend of the broadband network, high-speed subscriber and home networks are required. Thus, in recent times, wireless LAN (WLAN) and wireless Personal Area Network (WPAN) technologies, which make near-field communication possible in outdoor, home and an office, have attracted attention.

Among methods for implementing these technologies, to achieve wireless communication between a base station and a subscriber, that is, to transmit data to a base station from a central office without loss, radio-over-fiber (RoF) technology transmitting an RF signal through a fiber has been attracting attention. The RoF technology has been suggested to overcome a disadvantage of high signal loss when the RF signal is transmitted using a copper wire or a coaxial cable. Furthermore, the RoF technology has low loss (0.2 dB/km) of an optical fiber, and also has broadband transmission ability and characteristics unrelated to Electromagnetic Interference/Electromagnetic Compatibility (EMI/EMC). In order to realize the RoF technology, it is necessary to develop a low-cost optical transmitter/receiver module for a base station.

Hereinafter, a conventional optical module will be described with reference to FIG. 1, which is a schematic cross-sectional view of a conventional optical module.

Referring to FIG. 1, a conventional optical module 1 includes a module housing 2, a metal substrate 3 formed in the module housing 2, an optical device 4 formed on the metal substrate 3, and a lens 5. Also, at one side of the module housing 2, a ferrule housing 6 for supporting a ferrule fiber 7 is disposed. Optical coupling between the ferrule fiber 7 and the optical device 4 is formed by laser welding applied to the ferrule housing 6 and the ferrule fiber 7. The lens 5 serves to enhance the optical coupling between the optical device 4 and the ferrule fiber 7, and optical efficiency. The metal substrate 3 disposed in the module housing 2 effectively disperses heat generated in the optical device 4. The module housing 2 is formed of metal to hermetically seal the optical device 4.

However, according to the conventional configuration described above, the characteristics of the optical device may be changed by the laser welding process applied to the ferrule housing and the ferrule fiber to make an optical coupling between the ferrule fiber and the optical device. Also, in order to process a high-speed signal such as a millimeter wave using the conventional configuration, an expensive connector such as a K connector or a V connector has to be inserted into the module housing, which leads to a disadvantage of an increase in production cost of the module housing. In addition, since the module housing and its inner space are formed of metal and the module housing is large, there is a high probability that an input/output of the high-speed signal will generate resonance, and thus resonance prevention technology is needed.

In addition, according to the configuration described above, there is no space for an antenna and a filter in the conventional module housing, and thus a separate antenna and a separate filter have to be connected using a connector in order to build an antenna for communication between a base station and a wireless terminal and a filter for band selection in the module housing. Thus, the entire optical module becomes large and its production costs increase due to the expensive connector. Further, an optical signal has to pass through the connector which connects each component, which may cause loss of the optical signal.

### SUMMARY OF THE INVENTION

The present invention is directed to an optical hybrid module in which an optical device, an amplifier, a filter, an antenna and a bias circuit are hybrid-integrated to develop an optical transmitter/receiver module for a base station.

The present invention is also directed to an optical hybrid module which has a small footprint and low production costs, and may be used in a base station for a radio-over-fiber (RoF) link causing less loss in a millimeter wave band by hybrid-integrating an optical device, an amplifier, a filter and an antenna.

The present invention is also directed to an optical hybrid module which minimizes loss of signals by transmitting an RF signal through an optical fiber.

One aspect of the present invention provides an optical hybrid module, including: a silicon optical bench disposed on a substrate and having an optical fiber and an optical device; an amplifier disposed on the substrate and connected to the optical device disposed on the silicon optical bench to amplify a signal transmitted from the optical device; and an antenna disposed on the substrate to be connected to the amplifier and transmitting a signal amplified by the amplifier.

The optical device may be one of an optical receiver, an optical modulator and a laser diode. The optical device may be bonded on the silicon optical bench by a flip chip method, and passively aligned with the optical fiber formed on the silicon optical bench. The optical device may be connected to the silicon optical bench through a high-temperature solder. A groove may be formed in the silicon optical bench, and the optical fiber may be disposed in the groove. Index matching oil may be applied between the optical device and the optical fiber. A bias circuit may further be included on the substrate to provide a bias to the optical device and the amplifier.

The substrate may be a multi- or single-layer substrate. The substrate may be a ceramic substrate, a polymer substrate or a combined substrate thereof. The substrate having the optical device, the amplifier and the antenna may be connected to a main substrate or a mother board by a solder ball to receive a bias therefrom. An encapsulating agent may be applied to hermetically seal the space between the substrate and the main surface or the mother board.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 is a schematic cross-sectional view of a conventional optical hybrid module;

FIG. 2A is a perspective view of an optical hybrid module disposed on a substrate according to the present invention;

FIG. 2B is an enlarged perspective view of a back surface of the optical hybrid module illustrated in FIG. 2A;

FIG. 2C is an enlarged perspective view of a back surface of a silicon optical bench disposed on the optical hybrid module of FIG. 2B;

FIG. 3 is a perspective view illustrating coupling between an optical device and an optical fiber in the optical hybrid module according to the present invention;

FIG. 4 is a perspective view of an encapsulated state of the optical module after being mounted on a main substrate or a mother board according to the present invention; and

FIG. 5 is a perspective view of an optical hybrid module according to another exemplary embodiment of the present invention.

### DETAILED DESCRIPTION OF EXEMPLARY EMBODIMENTS

Hereinafter, the present invention will be described with reference to the accompanying drawings in detail.

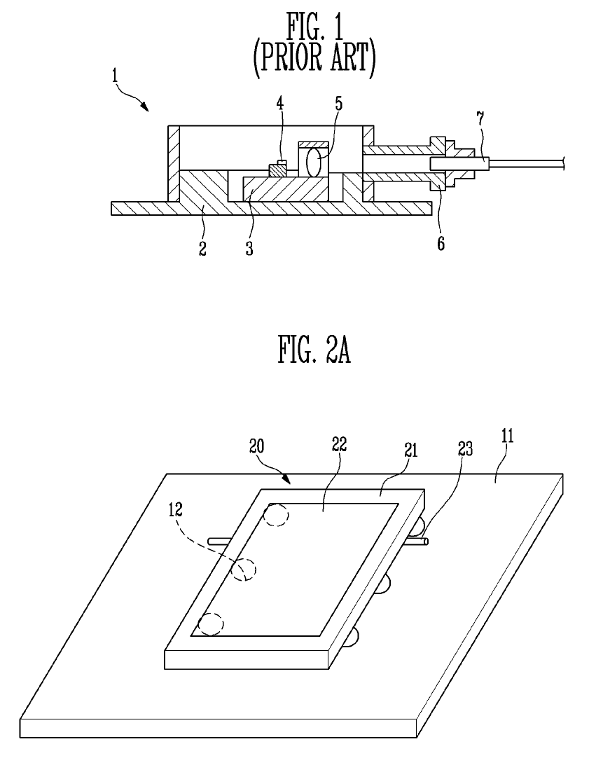

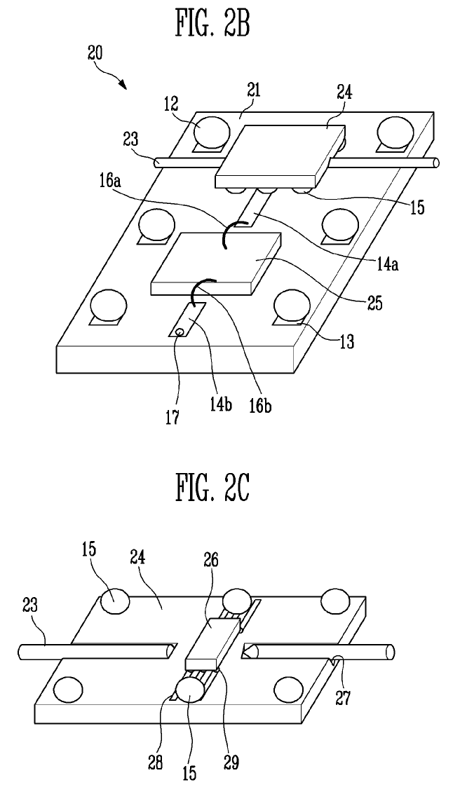

FIG. 2A is a perspective view of an optical hybrid module disposed on a substrate according to the present invention, FIG. 2B is an enlarged perspective view of a back surface of the optical hybrid module illustrated in FIG. 2A, and FIG. 2C is an enlarged perspective view of a back surface of a silicon optical bench disposed on the optical hybrid module of FIG. 2B. Generally, the optical hybrid module illustrated in FIGS. 2A to 2C serves to convert an electrical signal into an optical signal, and vice versa, and set up in a base station to be used in a radio-over-fiber (RoF) link system.

Referring to FIG. 2A, an optical module (optical hybrid module) 20 is formed on a main substrate or a mother board 11. The optical module 20 is mounted on the mother board 11 by several solder balls 12, and the optical module 20 includes a single- or multi-layer substrate 21, an antenna 22 formed on the substrate 21 and an optical fiber 23. A bias circuit (not illustrated) for providing a bias to a filter (not illustrated), the antenna 22, an optical device 26 (in FIG. 2C) and an amplifier 25 is included in the substrate 21, and the bias for driving the optical module is provided by the solder balls connected to the substrate 21. The substrate 21 may be a multi-layer ceramic substrate, a polymer substrate, or a combined substrate of ceramic and polymer, which may be formed in a single- or multi-layer structure. In the present embodiment, the substrate 21 is multi-layered, which is referred to below as a multi-layer substrate.

Particularly, FIG. 2B is an enlarged perspective view of the optical module 20, which is separated from the mother board 11, and then turned over to dispose the multi-layer substrate 21 on the bottom. Referring to FIG. 2B, the optical module 20 according to the present invention is formed on the multi-layer substrate 21, and includes a silicon optical bench 24 having an optical fiber 23, and an amplifier 25, which is adjacent to the silicon optical bench 24 and electrically connected to the silicon optical bench 24. Several metal patterns 13 are formed on the multi-layer substrate 21 to be electrically connected to other components, and solder balls 12 are disposed on the metal patterns 13.

A first metal interconnection 14a is formed on the multi-layer substrate 21 between the silicon optical bench 24 and the amplifier 25 to electrically connect them to each other. The silicon optical bench 24 is connected to one end of the first metal interconnection 14a through the solder ball 15, and one region of the amplifier 25 is connected to the other end of the first metal interconnection 14a through a bonding wire 16a. Thus, the silicon optical bench 24 is electrically connected to the amplifier 25. A second metal interconnection 14b is formed on the multi-layer substrate 21 to connect the amplifier 25 and the antenna 22 to each other. The other region of the amplifier 25 is connected to one end of the second metal interconnection 14b formed on the multi-layer substrate 21 through a bonding wire 16b, and the other end of the second metal interconnection 14b is connected to the antenna 22 through a via hole 17.

FIG. 2C is an enlarged perspective view of the silicon optical bench 24 of FIG. 2B, which is separated from the multi-layer substrate 21, and then turned over to dispose the optical fiber 23 on a top surface thereof.

Referring to FIG. 2C, the silicon optical bench 24 is mounted on the multi-layer substrate 21 by the solder ball 15, and an optical device 26 is disposed in the middle of the silicon optical bench 24. The optical device 26 is passively aligned with the optical fiber 23 on the silicon optical bench 24. The optical fiber 23 is disposed in a groove 27 formed on the silicon optical bench 24. The groove 27 is formed in a V shape in the present embodiment, and the optical fiber 23 disposed therein is fixed with an adhesive agent or a solder. The optical device 26 is connected to the silicon optical bench 24 through a metal interconnection 28 and solders 29 and 15. One end of the metal interconnection 28 is connected to the optical device 26 through the high-temperature solder 29, and the other end thereof is connected to the metal interconnection 14a through the solder ball 15. All signals transmitted to or through the optical device 26 are provided to the metal interconnection 28 through the high-temperature solder 29. The high-temperature solder 29 is usually formed of AuSn and has a high melting point, so that the solder does not melt when adhering the solder ball 15 or when performing a packaging process such as die bonding and wire bonding. Therefore, the position of the optical device 26 is not changed. In the present embodiment, the optical device 26 is an optical receiver. Further, the optical device 26 is electrically connected to the amplifier 25 through the solder 15.

According to the configuration described above, an optical signal is transmitted to the optical device 26 through the optical fiber 23. The optical signal transmitted to the optical device 26 is converted into an electrical signal by the optical device 26, and the electrical signal is transmitted to the first metal interconnection 14a on the multi-layer substrate 21 through the solder 15. The signal transmitted to the first metal interconnection 14a is amplified by the amplifier 25, and then transmitted to a wireless terminal (not illustrated) through an antenna 22 after passing through a filter (not illustrated) formed in the multi-layer substrate 21 through the via hole 17.

If the optical device 26 described above is an optical modulator, the signal received through the antenna 22 from the wireless terminal is filtered by the filter in the multi-layer substrate 21, and transmitted to the metal interconnection 14a and the bonding wire 16 through the via hole 17. The input signal is amplified by the amplifier 25, and transmitted to the optical device 26 (optical modulator) formed on the silicon optical bench 25. The optical modulator 26 modulates the optical signal received through the optical fiber 23 into an electrical signal. The modulated signal is transmitted to a central office.

FIG. 3 is a perspective view of an optical hybrid module according to the present invention in which the optical device is connected to the optical fiber. Referring to FIG. 3, index matching oil 30 is applied between the optical device 26 and the optical fiber 23 to increase optical coupling. To be more specific, the reason that the index matching oil 30 is applied between the optical device 26 and the optical fiber 23 is to prevent partial loss of optical signals provided by the optical fiber 23 in the air due to large differences in index between the optical fiber 23 and the air and between the air and the optical device 26. That is, when the index matching oil 30 is applied between the optical device 26 and the optical fiber 23, the differences in index between the optical fiber 23 and the air and between the air and the optical device 26 are reduced, thereby decreasing an amount of the optical signals lost in the air, and thus increasing the optical coupling.

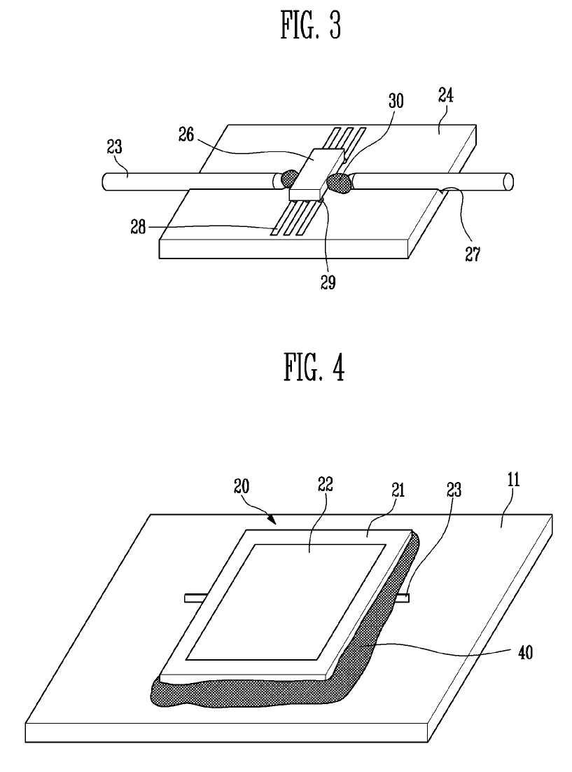

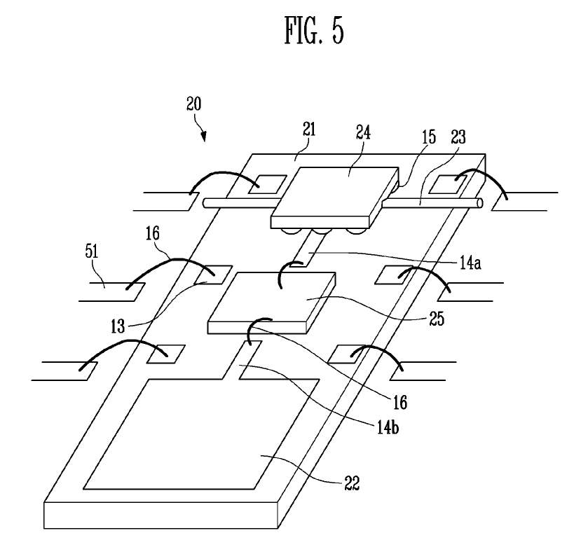

FIG. 4 is a perspective view of an encapsulated optical module after the optical module is mounted on a main board or a mother board. Referring to FIG. 4, in order to seal a space between the optical module 20 and the mother board 11, an encapsulating agent 40 is applied therebetween. The encapsulating agent 40 may prevent moisture or mechanical impact from being applied to the optical device 26 and the metal interconnections 14a, 14b and 28 disposed on the optical module 20, and also prevent destruction of the solder ball 12 due to a difference in thermal expansion coefficient between the optical module 20 and the mother board 11.

FIG. 5 is a perspective view of an optical hybrid module according to another exemplary embodiment of the present invention. Referring to FIG. 5, an optical hybrid module 20 includes a multi-layer substrate 21, a silicon optical bench 24 formed on the multi-layer substrate 21 and having an optical fiber 23, an amplifier 25 electrically connected to the silicon optical bench 24 and an antenna 22 electrically connected to the amplifier 25. In the present embodiment, the silicon optical bench 24, the amplifier 25 and the antenna 22 are aligned in one plane. The silicon optical bench 24 has an optical device 26 (in FIG. 2C) to be connected to the optical fiber 23, and biases required for the optical device 26 and the amplifier 25 are provided through metal interconnections 14a and 14b and bonding wires 16 on a main substrate or a mother board 13. Meanwhile, in the present embodiment, the optical module 20 is connected to the main substrate or the mother board 13 using a metal interconnection 51 and a bonding wire 16, instead of a solder ball. Moreover, the optical module 20, and the main substrate or the mother board 13 are hermetically sealed with an encapsulating agent.

According to the configuration described above, an optical signal is transmitted to the optical device 26 through the optical fiber 23. The optical signal transmitted to the optical device 26 is converted into an electrical signal by the optical device 26, and then transmitted to the metal interconnection 14a on the multi-layer substrate 21 through the solder ball 15. The signal transmitted to the metal interconnection 14a is amplified by the amplifier 25, and then transmitted to a wireless terminal (not illustrated) through the antenna 22 formed on the multi-layer substrate 21.

In the present invention, an optical device is bonded to a silicon optical bench with a flip chip, and optically coupled with an optical fiber using index matching oil, and thus a metal housing is not needed.

Also, the present invention may have an antenna and a filter on a single- or multi-layer substrate and provide biases required for an optical device and an amplifier by a solder ball, thereby embodying a foot-print module. Therefore, an expensive connector is required, and production costs can be reduced. Even when a high-speed signal such as a millimeter wave is processed, resonance can be prevented because of a small space provided by a solder ball and a ground on a substrate.

Also, the optical module, except the antenna, is hermetically sealed with an encapsulating agent to be protected from external impact and moisture, and to effectively prevent destruction of the solder ball due to a difference in thermal expansion coefficient between the module and the substrate.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. An optical hybrid module, comprising:
a silicon optical bench disposed on a substrate and having an optical fiber and an optical device;
an amplifier disposed on the substrate and connected to the optical device disposed on the silicon optical bench to amplify a signal transmitted from the optical device; and
an antenna disposed on the substrate to be connected to the amplifier and transmitting a signal amplified by the amplifier.

2. The module according to claim 1, wherein the optical device comprises one of an optical receiver, an optical modulator and a laser diode.

3. The module according to claim 2, wherein the optical device is bonded on the silicon optical bench by a flip chip method, and passively aligned with the optical fiber formed on the silicon optical bench.

4. The module according to claim 3, wherein the optical device is connected to the silicon optical bench through a high-temperature solder or adhesives.

5. The module according to claim 3, wherein the silicon optical bench has a groove and the optical fiber is disposed in the groove to be connected to each other.

6. The module according to claim 3, wherein index matching oil is applied between the optical device and the optical fiber.

7. The module according to claim 1, further comprising:
the antenna, the filter, a bias circuit for providing a bias to the optical device and the amplifier on the substrate.

8. The module according to claim 7, wherein the substrate is a multi- or single-layer substrate.

9. The module according to claim 8, wherein the substrate comprises a ceramic substrate, a polymer substrate or a combined substrate thereof.

10. The module according to claim 1, wherein the substrate having the optical device, the amplifier and the antenna thereon is connected to a main substrate through the solder ball to receive a bias from the main substrate.

11. The module according to claim 10, wherein an encapsulating agent is applied between the main substrate and the substrate to be hermetically sealed.
